(19) United States
(12) Patent Application Publication
(10) Pub. No.: US 2009/0030114 A1
(43) Pub. Date: Jan. 29, 2009

(54) Fluoropolymer emulsions

(76) Inventors: Ying Wang, West Chester, PA (US); Peter Michael Murphy, Chadds Ford, PA (US); Sheng Peng, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/881,129

(22) Filed: Jul. 25, 2007

(51) Int. Cl. C08K 9/10; C08F 120/06

(52) U.S. Cl. 523/201

(57) ABSTRACT

A core-shell emulsion polymer comprising
A) a core composition comprising components (a) and (b):
   (a) from about 40 to about 95% of styrene, alkyl substituted styrene, or alkyl (meth)acrylate; and
   (b) from about 5 to about 60% of vinylidene chloride, vinyl chloride, or combinations thereof; and
B) a shell composition components (c) and (d):
   (c) from about 50 to about 85% of
      (I) R_{f}¹(CH₂)ₘ Z-C(O)—C(R¹)═CH₂
      (II) R_{f}²(CH₂CF₂)_{q}(CH₂CH₂)ᵣZ-C(O)—C(R¹)═CH₂, or
      (III) R_{f}³O(CF₂CF₂)_{q}(CH₂CH₂)ᵣZ-C(O)—C(R¹)═CH₂
         wherein
R¹ is hydrogen, Cl, F or CH₃;
Z is —O—, —NH— or —S—;
R_{f}¹ and R_{f}² are each a C₄ or C₆ perfluoroalkyl; and
R_{f}³ is a C₂ to C₇ perfluoroalkyl optionally interrupted by one to three ether oxygens; and
   (d) from about 15 to about 50% of styrene, alkyl substituted styrene, or alkyl (meth)acrylate,
      provided that i) the core composition comprises from about 20 to about 75% of the polymer; ii) when R_{f}¹ or R_{f}² has 4 carbons, R¹ is CH₃; and iii) when R_{f}³ has 2 or 3 carbons, R¹ is CH₃.

### FIELD OF INVENTION

This invention relates to a composition comprising a fluorinated copolymer emulsion useful for imparting oil repellency and water repellency to textiles, the copolymer derived from polymerization of monomers comprising fluorinated acrylates, and alkyl (meth)acrylates in a two-stage core-shell emulsion polymerization.

### BACKGROUND

Various compositions are known to be useful as treating agents to provide surface effects to substrates. Surface effects include repellency to moisture, soil, and stains, and other effects, which are particularly useful for fibrous substrates such as fibers, fabrics, textiles, carpets, paper, leather, and other such substrates. Many such treating agents are fluorinated polymers or copolymers.

Fluorinated polymer compositions having utility as fibrous substrate treating agents generally contain pendant perfluoroalkyl groups which provide oil- and water-repellency when the compositions are applied to fibrous substrate surfaces. The perfluoroalkyl groups are generally attached by various connecting groups to polymerizable groups not containing fluorine. The resulting monomer is then generally copolymerized with other monomers, which confer additional favorable properties to the substrates. Various specialized monomers may be incorporated to impart improved cross-linking, latex stability and substantivity. Since each ingredient may impart some potentially undesirable properties in addition to its desirable ones, the specific combination is directed to the desired use. These polymers are generally marketed as aqueous emulsions for easy application to the fibrous substrates. U.S. Pat. No. 6,479,605 discloses a fluorinated copolymer useful for treating fibrous substrates to provide oil repellency and water repellency.

Typically relatively high levels of fluorinated monomers are required for adequate performance. For instance, U.S. Pat. No. 6,479,605 discloses formulations that have about 40 to about 75 weight % of fluorinated monomer in useful formulations. Furthermore, to achieve effective repellency the monomers typically used in commercial formulations have long perfluorinated alkyl groups, usually mixtures, with a large fraction of the perfluorinated alkyl groups greater than six carbon atoms. It is desired to have treating agents for fibrous substrates containing less fluorine while maintaining repellency performance. Lee, et al, in U.S. Pat. No. 6,790,898, discloses an emulsion particle with a core-shell structure wherein the shell contained many perfluorinated groups and the core contained few or no perfluorinated groups. In this core-shell structure, the hydrophobic shell was designed to provide high levels of hydrophobic functionality at the air-material interface. However, the compositions were designed to provide polymer films, and not surface treatment agents for fibrous products.

Core-shell emulsions useful to provide good to excellent oil- and water-repellency to fibrous substrates, with good durability of such repellency during washing cycles while also having low levels of fluorinated monomers, preferably below 50% by weight are desired. Furthermore it is desirable that such core-shell emulsions have short perfluorinated alkyl groups, preferably with no perfluorinated alkyl groups higher than six carbon atoms. The present invention provides such core-shell emulsions.

### SUMMARY OF INVENTION

The present invention comprises an oil- and water-repellant core-shell emulsion polymer comprising

A) a core composition, prepared from a first polymerization, comprising, on a water-free and surfactant-free basis, components (a) and (b):
(a) from about 40 to about 95% by weight of one or more monomers selected from the group consisting of styrene; alkyl substituted styrene, wherein said alkyl is a linear, cyclic or branched hydrocarbon having 1 to about 18 carbons; and alkyl (meth)acrylate wherein said alkyl is a linear, cyclic or branched hydrocarbon having from about 6 to about 18 carbons; and
(b) from about 5 to about 60% by weight of one or more monomers selected from the group consisting of vinylidene chloride; vinyl chloride; and combinations thereof; and

B) a shell composition, prepared from a second polymerization in the presence of the core composition, comprising, on a water-free and surfactant-free basis, components (c) and (d):
(c) from about 50 to about 85% by weight of one or more fluorinated monomers of formula (I), (II) or (III):
   (I) R_{f}¹(CH₂)ₘ Z-C(O)—C(R¹)═CH₂
   (II) R_{f}²(CH₂CF₂)_{q}(CH₂CH₂)ᵣZ-C(O)—C(R¹)═CH₂
   (III) R_{f}³O(CF₂CF₂)_{q}(CH₂CH₂)ᵣZ-C(O)—C(R¹)═CH₂
      wherein

m is an integer of 1 to about 6;

q and r are each independently an integer of 1 to about 3;

R¹ is hydrogen, Cl, F or CH₃;

Z is —O—, —NH— or —S—;

R_{f}¹ is a linear or branched perfluoroalkyl group having 4 or 6 carbon atoms;

R_{f}² is a linear or branched perfluoroalkyl group having from about 4 to about 6 carbon atoms; and

R_{f}³ is a linear or branched perfluoroalkyl group having from about 2 to about 7 carbon atoms optionally interrupted by one, two or three ether oxygen atoms; and

(d) from about 15 to about 50% by weight of monomers selected from the group consisting of styrene; alkyl substituted styrene wherein said alkyl is a linear, cyclic or branched hydrocarbon having 1 to 18 carbons; and alkyl (meth)acrylate wherein said alkyl is a linear, cyclic or branched hydrocarbon having 6 to 18 carbons;

provided that i) the core composition comprises from about 20 to about 75% by weight of the polymer; ii) when R_{f}¹ or R_{f}² has 4 carbon atoms, R¹ is CH₃; and iii) when R_{f}³ has 2 or 3 carbon atoms, R¹ is CH₃.

The present invention further comprises a method of treating a fibrous substrate to impart oil repellency and water repellency comprising applying to the surface of the substrate a core-shell emulsion polymer as described above.

The present invention further comprises a fibrous substrate having applied to its surface a core-shell emulsion polymer as disclosed above.

### DETAILED DESCRIPTION OF INVENTION

Herein all trademarks are designated with capital letters.

The term “(meth)acrylate” encompasses esters of methacrylic acid and acrylic acid unless specifically stated otherwise. For instance, hexyl (meth)acrylate encompasses both hexyl acrylate and hexyl methacrylate.

All patents cited herein are hereby incorporated by reference.

Herein the terms “fluorinated acrylate(s)” “fluorinated thioacrylate(s)” and “fluorinated acrylamide(s)” refer to compounds of formula (I), (II), and (III) as described above, wherein R¹ is selected from the group consisting of H, Cl, F, and CH₃, unless specifically defined otherwise.

The core-shell emulsion polymer of the present invention is prepared by a first polymerization of components (a) and (b) as described above to form the core composition, followed by a second polymerization in the presence of the core composition of components (c) and (d) as described above to form the shell composition.

Within the core-shell polymer of the invention, the core composition comprises, on a water- and surfactant-free basis, from about 40 to about 95% by weight of component (a) herein defined as one or more monomers selected from the group consisting of styrene; alkyl substituted styrene, wherein said alkyl is a linear, cyclic or branched hydrocarbon having 1 to about 18 carbons; and alkyl (meth)acrylate wherein said alkyl is a linear, cyclic or branched hydrocarbon having from about 6 to about 18 carbons. Preferably the proportion of component (a) in the core copolymer composition is between about 55% to about 90% by weight.

Specific monomers useful in component (a) include stearyl (meth)acrylate, lauryl(meth)acrylate, 2-ethylhexyl(meth)acrylate, tridecyl (meth)acrylate, hexyl(meth)acrylate, cyclohexyl(meth)acrylate, styrene, alpha-methylstyrene, and others. Preferred monomers are stearyl (meth)acrylate, 2-ethylhexyl(meth)acrylate, hexyl(meth)acrylate, cyclohexyl(meth)acrylate, lauryl(meth)acrylate, tridecyl (meth)acrylate, or a mixture thereof. Of the foregoing, stearyl acrylate and stearyl methacrylate are most preferred. Such monomers are commercially available.

The core composition further requires from about 5 to about 60% by weight, and preferably about 10 to about 45% by weight, of component (b), herein defined as one or more monomers selected from the group consisting of vinylidene chloride; vinyl chloride, and combinations thereof. Preferably component (b) consists essentially of vinylidene chloride. Such monomers are commercially available.

In one embodiment the first-stage polymerization of the core composition further comprises component (e) herein defined as from about 0.5 to about 10% by weight of one more monomers selected from the group consisting of 2- and 4-chloromethyl styrene, vinyl acetate, N-methyloyl methacrylamide, N-methyloyl acrylamide, and monomers of the formula:

R²—(OCH₂CH₂)ₐ—O—C(O)—C(R)═CH₂

wherein a is 1 to about 10, R is H or —CH₃, and R² is hydrogen, C₁-C₄ alkyl, or —C(O)—C(R)═CH₂. Preferred monomers are 2-hydroxyethyl methacrylate (wherein a is 1), N-methyloyl acrylamide, and the ethoxylated monomers. Preferably N-methyloyl acrylamide is present in proportions from about 0.5% to about 3% by weight, preferably from about 0.7% to about 1.5% by weight. Preferably hydroxyethyl (meth)acrylate is present in proportions from about 0.5% to about 3% by weight, preferably from about 0.7% to about 1.5% by weight. The ethoxylated monomers, preferably wherein a is from about 4 to about 10 are preferred, and present in proportions from about 1% to about 5% by weight, preferably about 1.5% to about 3% by weight.

Within the core-shell emulsion polymer of the invention, the shell composition comprises, on a water- and surfactant-free basis, from about 50 to about 85% by weight, preferably about 60 to about 80% by weight, and more preferably about 70 to about 80% by weight, of component (c) herein defined as one or more fluorinated monomer(s) of formula (I), (II) and (III).
(I) R_{f}¹(CH₂)ₘ Z-C(O)—C(R¹)═CH₂
(II) R_{f}²(CH₂CF₂)_{q}(CH₂CH₂)ᵣZ-C(O)—C(R¹)═CH₂
(III) R_{f}³O(CF₂CF₂)_{q}(CH₂CH₂)ᵣZ-C(O)—C(R¹)═CH₂
   wherein

m is an integer of 1 to about 6;

q and r are each independently an integer of 1 to about 3;

R¹ is hydrogen, Cl, F or CH₃;

Z is —O—, —NH— or —S—;

R_{f}¹ is a linear or branched perfluoroalkyl group having 4 or 6 carbon atoms;

R_{f}² is a linear or branched perfluoroalkyl group having from about 4 to about 6 carbon atoms; and

R_{f}³ is a linear or branched perfluoroalkyl group having from about 2 to about 7 carbon atoms optionally interrupted by one, two or three ether oxygen atoms. Such monomers are prepared as described herein below.

Preferred compositions are wherein component (c) comprises the fluorinated monomer of formula (I), wherein Z is —O—, m is 2, R¹ is CH₃, and R_{f}¹ has 6 carbon atoms. Another preferred embodiment is wherein component (c) comprises a mixture of fluorinated monomers of formula (I), wherein Z is —O—, m is 2, R¹ is CH₃, and R_{f}¹ has 4 and 6 carbon atoms. Another preferred embodiment is wherein component (c) comprises one or more fluorinated monomers is of formula (II), wherein Z is —O—, q is 1 or 2, r is 1, R¹ is CH₃, and R_{f}² has 6 carbon atoms. Another preferred embodiment is wherein component (c) comprises the fluorinated monomer of formula (III), wherein Z is —O—, q is 1, r is 1, R¹ is CH₃, and R_{f}³ has 3 carbon atoms.

The shell composition further requires from about 15 to about 50%, preferably 15 to 40% by weight, and more preferably 15 to about 30% by weight, of component (d) herein defined as one or more monomers selected from the group consisting of styrene; alkyl substituted styrene wherein said alkyl is a linear, cyclic or branched hydrocarbon having 1 to 18 carbons; and alkyl (meth)acrylate wherein said alkyl is a linear, cyclic or branched hydrocarbon having 6 to 18 carbons. Specific monomers useful in component (d) include stearyl (meth)acrylate, lauryl(meth)acrylate, 2-ethylhexyl(meth)acrylate, tridecyl (meth)acrylate, hexyl(meth)acrylate, cyclohexyl(meth)acrylate, styrene, alpha-methylstyrene, and others. Preferred monomers are stearyl (meth)acrylate, 2-ethylhexyl (meth)acrylate, hexyl(meth)acrylate, cyclohexyl(meth)acrylate, lauryl (meth)acrylate, tridecyl (meth)acrylate, or a mixture thereof. Of the foregoing, stearyl acrylate and stearyl methacrylate are most preferred. Such monomers are commercially available.

Preferably the shell composition further comprises about 5 to about 15% by weight, and more preferably about 2 to about 10% by weight, of one or more monomers selected from component (e) as defined above for the core composition. A more preferred embodiment is wherein the shell composition further comprises about 2 to 10% by weight of monomers selected from the group: 2-hydroxyethyl methacrylate, N-methyloyl acrylamide, and the ethoxylated monomers of the formula:

H—(OCH₂CH₂)ₐ—O—C(O)—C(R)═CH₂

wherein a is from about 4 to about 10, and R is H or —CH₃.

One or more specialized monomers optionally are incorporated into the core or shell polymers of the present invention in lesser amounts, e.g., 0.1-5% by weight, to impart improved cross-linking, latex stability and substantivity. These materials include 0.1-2% by weight of 2-hydroxybutyl (meth)acrylate, 0.1 to 2% by weight of 2-hydroxypropyl meth)acrylate, 0.1 to 2% by weight of 3-chloro-2-hydroxypropyl (meth)acrylate, or 0.1 to 2% by weight of glycidyl (meth)acrylate.

Cationic, anionic and nonionic surfactants used in this invention are any of those surfactants commonly used for preparing aqueous emulsions. Suitable cationic agents include, for example, dodecyltrimethylammonium acetate, trimethyltetradecylammonium chloride, hexadecyltrimethylammonium bromide, trimethyloctadecylammonium chloride, ethoxylated alkyl amine salts, and others. A preferred example of a suitable cationic surfactant is the methyl chloride salt of an ethoxylated alkyl amine salt such as an 18-carbon alkylamine with 15 moles of ethylene oxide such as ETHOQUAD 18/25 available from Akzo Nobel, Chicago, Ill. Nonionic surfactants which are suitable for use herein include condensation products of ethylene oxide with C₁₂-C₁₈ fatty alcohols, C₁₂-C₁₈ fatty acids, alkyl phenols having 8 to 18 carbon atoms in the alkyl group, C₁₂-C₁₈ alkyl thiols and C₁₂-C₁₈ alkyl amines. A preferred example of a suitable nonionic surfactant, if used in combination with the cationic surfactant, is an ethoxylated tridecyl alcohol surfactant such as MERPOL SE available from Stepan Company, Northfield, Ill. Suitable anionic surfactants which are used herein include alkyl carboxylic acids and their salts, alkyl hydrogen sulfates and their salts, alkyl sulfonic acids and their salts, alkyl ethoxy sulfates and their salts, alpha olefin sulfonates, alkylamidoalkylene sulfonates, and the like. Generally preferred are those wherein the alkyl groups have 8 to 18 carbon atoms. Especially preferred is an alkyl sulfate sodium salt where the alkyl group averages about 12 carbons, such as SUPRALATE WAQE surfactant, available from Witco Corporation, Greenwich, Conn.

In addition to the above ingredients and water, the final emulsion polymer optionally contains auxiliary solvents such as tripropylene glycol, dipropylene glycol, hexylene glycol, propylene glycol, ethylene glycol, acetone and others. These may be present up to about 10% by weight, preferably between 5% and 10% by weight, of the wet emulsion.

Emulsion polymerization is employed to prepare the polymers of this invention. The process is carried out in two polymerization stages. The first polymerization provides the core polymer (emulsion 1 in the examples herein). The process is carried out in a reaction vessel fitted with a stirrer and external means for either heating or cooling the charge. The monomers to be polymerized together are emulsified in an aqueous solution containing a suitable surfactant, and optionally an organic solvent, to provide an emulsion concentration of 5% to 50% by weight. Usually the temperature is raised to about 40° C. to about 70° C. to effect polymerization in the presence of an added catalyst. A suitable catalyst is any of the commonly known agents for initiating the polymerization of an ethylenically unsaturated compound. Such commonly employed initiators include 2,2′-azodi-isobutyramidine dihydrochloride; 2,2′-azodiisobutyro-nitrile; 2,2′-azobis(2-methylpropionamidine) dihydrochloride and 2,2′ azobis(2,4-dimethyl-4-methoxyvaleronitrile. The concentration of added initiator is usually 0.1 to about 2% by weight, based on the weight of the monomers to be polymerized. To control the molecular weight of the resulting polymer, small amounts of a chain-transfer agent, such as an alkylthiol of 4 to about 18 carbon atoms, is optionally present during polymerization. In the second stage of the polymerization, the shell emulsion is then added to the same reactor containing the core emulsion. The monomers to be polymerized for the shell are emulsified in an aqueous solution containing a suitable surfactant, and optionally an organic solvent, to provide an emulsion concentration of from about 5% to about 50% by weight (emulsion 2 in the examples herein). This emulsion is added to the core polymer and polymerization is initiated, usually at a temperature of about 40° C. to about 70° C., in the presence of an added catalyst, as described for the core polymerization.

After the second stage polymerization is complete, either an anionic or cationic surfactant is added to the emulsion. If an anionic surfactant is used during polymerization, a cationic surfactant is added after polymerization. If a cationic surfactant is used during polymerization, an anionic surfactant is added after polymerization. Both an anionic and cationic surfactant are present in the emulsions of the present invention in order to achieve the zeta potential desired for a particular application, and to have the desired chemical and mechanical stability under conditions of high alkalinity, high anionic concentration, or high shear during use of the emulsion.

In another embodiment, the composition of the invention can include other additives commonly used with such treating agents or finishes such as pH adjusters, cross linkers, wetting agents, wax extenders, and other additives known by those skilled in the art. Examples of such finishes or agents include processing aids, foaming agents, lubricants, anti-stains, and the like. In particular for fibrous substrates, when synthetic or cotton fabrics are treated, a wetting agent can be used, such as ALKANOL 6112 available from E.I. du Pont de Nemours and Company, Wilmington, Del. When cotton or cotton-blended fabrics are treated, a wrinkle-resistant resin can be used such as PERMAFRESH EPC available from Omnova Solutions, Chester, S.C.

Optionally a blocked isocyanate to further promote durability can be added to the fluoropolymer of the present invention, for example, as a blended isocyanate. An example of a suitable blocked isocyanate is HYDROPHOBO XAN available from Ciba Specialty Chemicals, High Point N.J. Other commercially available blocked isocyanates are also suitable for use herein. The desirability of adding a blocked isocyanate depends on the particular application for the treating agent. For most of the presently envisioned applications, it does not need to be present to achieve satisfactory cross-linking between chains or bonding to the substrate. When added as a blended isocyanate, amounts up to about 20% by weight may be added.

The fluorinated acrylates and fluorinated thioacrylates of formula (I), (II), and (III), useful in forming the compositions of the invention are prepared from the corresponding fluorinated alcohols and fluorinated thiols by esterification with acrylic acid, methacrylic acid, 2-chloroacrylic acid or 302-fluoroacrylic acid using procedures as described in U.S. Pat. No. 3,282,905 and EP 1632542 A1. Alternatively, acrylate and methacrylate esters of formula (II) can be made from the corresponding nitrate esters according to the procedures disclosed in U.S. Pat. No. 3,890,376.

The fluorinated acrylamides of formula (I), (II), and (III), useful in forming the compositions of the invention, are prepared from the corresponding fluorinated amines by condensation with acrylic acid chloride, methacrylic acid chloride, 2-chloroacrylic acid chloride or 2-fluoroacrylic acid chloride in the presence of a base, for instance, triethylamine (TEA). Typically a nonhydroxylic hydrocarbon solvent such as toluene or xylenes or a halocarbon such as dichloromethane is used in the condensation.

Fluorinated alcohols useful in forming fluorinated acrylates useful in the invention include those of formulas (IVa), (IVb) and (IVc):

R_{f}¹(CH₂)ₘOH (IVa)

R_{f}²(CH₂CF₂)_{q}(CH₂CH₂)ᵣOH (IVb)

R_{f}³⁰(CF₂CF₂)_{q}(CH₂CH₂)ᵣOH (IVc)

In formula (IVa) the perfluoroalkyl group preferably is linear, although compositions containing branch-chain perfluoroalkyl groups are suitable. The perfluoroalkylethanols, wherein m is 2, and R_{f}¹ has 4 or 6 carbon atoms, are available by fractional distillation of the commercially available telomer mixture of perfluoroalkylethanols. Specific fluorinated alcohols of formula (IVa) that are commercially available include 1H,1H,2H,2H-perfluoro-1-hexanol, 1H,1H,-perfluoro-1-hexanol, and 1H,1H,2H,2H-perfluoro-1-octanol.

Fluorinated telomer alcohols of formula (IVb), wherein R_{f}² is a linear or branched perfluoroalkyl group having 4 to 6 carbon atoms, are available by synthesis according to Scheme 1.

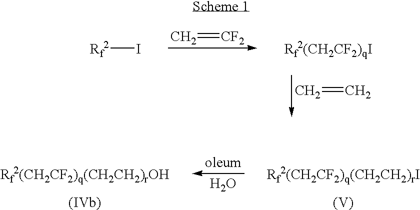

The telomerization of vinylidene fluoride (VDF) with linear or branched perfluoroalkyl iodides is well known, and produces compounds of the structure R_{f}²(CH₂CF₂)_{q}I, wherein, q is 1 or more and R_{f}² is a C₄ to C₆ perfluoroalkyl group. For example, see Balague, et al, “Synthesis of fluorinated telomers, Part 1, Telomerization of vinylidene fluoride with perfluoroalkyl iodides”, J. Flour Chem. (1995), 70(2), 215-23. The specific telomer iodides are isolated by fractional distillation. The telomer iodides can be treated with ethylene by procedures described in U.S. Pat. No. 3,979,469, to provide the telomer ethylene iodides (V) wherein r is 1 to 3 or more. The telomer ethylene iodides (V) can be treated with oleum and hydrolyzed to provide the corresponding telomer alcohols (IVb) according to procedures disclosed in WO 95/11877. Alternatively, the telomer ethylene iodides (V) can be treated with N-methyl formamide followed by ethyl alcohol/acid hydrolysis.

Specific fluorinated telomer alcohols (IVa), and (IVb) derived from telomerization of vinylidene fluoride and ethylene, and useful in forming fluorinated acrylates useful in the invention include those listed in Table 1A. The groups C₃F₇, C₄F₉, and C₆F₁₃, referred to in the list of specific alcohols, in Tables 1A and 1B, and in the examples herein, refer to linear perfluoroalkyl groups unless specifically indicated otherwise.

TABLE 1A

| Compound | Structure |
|---|---|
| A1 | C₄F₉CH₂CH₂OH, |
| A2 | C₄F₉(CH₂CH₂)₂OH, |
| A3 | C₆F₁₃CH₂CH₂OH, |
| A4 | C₆F₁₃(CH₂CH₂)₂OH, |
| A5 | C₆F₁₃(CH₂CH₂)₃OH, |
| A6 | C₄F₉CH₂CF₂CH₂CH₂OH, |
| A7 | C₄F₉(CH₂CF₂)₂CH₂CH₂OH, |
| A8 | C₄F₉(CH₂CF₂)₃CH₂CH₂OH, |
| A9 | C₄F₉CH₂CF₂(CH₂CH₂)₂OH, |
| A10 | C₄F₉(CH₂CF₂)₂(CH₂CH₂)₂OH, |
| A11 | C₆F₁₃CH₂CF₂CH₂CH₂OH, |
| A12 | C₆F₁₃(CH₂CF₂)₂CH₂CH₂OH, |
| A13 | C₆F₁₃(CH₂CF₂)₃CH₂CH₂OH, |
| A14 | C₆F₁₃CH₂CF₂(CH₂CH₂)₂OH, |
| A15 | C₆F₁₃(CH₂CF₂)₂(CH₂CH₂)₂OH. |

Fluorinated alcohols of formula (IVc), wherein q is 1 and R_{f}³ is a linear or branched perfluoroalkyl group having 2 to 7 carbon atoms optionally interrupted by one, two or three ether oxygen atoms, are available by synthesis according to Scheme 2.

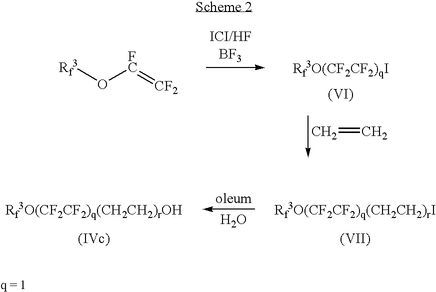

The perfluoroalkyl ether iodides (VI) are made by the procedure described in Example 8 of U.S. Pat. No. 5,481,028, using perfluoroalkyl vinyl ethers as a starting point. In the second reaction in Scheme 2, the perfluoroalkyl ether iodide (VI) is reacted with an excess of ethylene at an elevated temperature and pressure to provide telomer ethyl iodide (VII). While the addition of ethylene can be carried out thermally, the use of a suitable catalyst is preferred. Preferably the catalyst is a peroxide catalyst such as benzoyl peroxide, isobutyroyl peroxide, propionyl peroxide, or acetyl peroxide. More preferably the peroxide catalyst is benzoyl peroxide. The temperature of the reaction is not limited, but a temperature in the range of 110° C. to 130° C. is preferred. The reaction time may vary with the catalyst and reaction conditions, but we have found 24 hours (h) to be adequate. The product may be purified by any means that separates unreacted starting material from the final product, but distillation is preferred. Satisfactory yields up to 80% of theory have been obtained using about 2.7 mols of ethylene per mole of perfluoalkyl ether iodide, a temperature of 110° C. and autogenous pressure, a reaction time of 24 h, and purifying the product by distillation. The perfluoroalkylether ethyl iodides (VII) can be treated with oleum and hydrolyzed to provide the corresponding alcohols (IVc) according to procedures disclosed in WO 95/11877. Alternatively, the perfluoroalkylether ethyl iodides can be treated with N-methyl formamide followed by ethyl alcohol/acid hydrolysis.

The higher homologs of (IVc) wherein q is 2 or 3 are available by telomerization of tetrafluoroethylene with the perfluoroalkyl ether iodides (VI) wherein q is 1, followed by isolation of specific telomers by distillation, and then telomerization with ethylene. The higher homologs (r is 2 or 3) of telomer ethylene iodides are available with excess ethylene at high pressure.

Specific fluorinated alcohols (IVc) useful in forming fluorinated acrylates useful in the invention include those listed in Table 1B

TABLE 1B

| Compound | Structure |
|---|---|
| B1 | C₂F₅OCF₂CF₂CH₂CH₂OH, |
| B2 | C₂F₅O(CF₂CF₂)₂CH₂CH₂OH, |
| B3 | C₃F₇OCF₂CF₂CH₂CH₂OH, |
| B4 | C₃F₇O(CF₂CF₂)₂CH₂CH₂OH, |
| B5 | C₄F₉OCF₂CF₂CH₂CH₂OH, |
| B6 | C₄F₉O(CF₂CF₂)₂CH₂CH₂OH, |
| B7 | C₆F₁₃OCF₂CF₂CH₂CH₂OH, |
| B8 | C₆F₁₃O(CF₂CF₂)₂CH₂CH₂OH, |
| B9 | CF₃OCF(CF₃)CF₂OCF₂CF₂CH₂CH₂OH, |
| B10 | CF₃OCF(CF₃)CF₂O(CF₂CF₂)₂CH₂CH₂OH, |
| B11 | C₂F₅OCF(CF₃)CF₂OCF₂CF₂CH₂CH₂OH, |
| B12 | C₂F₅OCF(CF₃)CF₂O(CF₂CF₂)₂CH₂CH₂OH, |
| B13 | C₃F₇OCF(CF₃)CF₂OCF₂CF₂CH₂CH₂OH, |
| B14 | C₃F₇OCF(CF₃)CF₂O(CF₂CF₂)₂CH₂CH₂OH, |

The corresponding thiols of alcohols (IVa) (IVb) and (IVc) are available from the telomer ethylene iodides by treatment with a variety of reagents according to procedures described in J. Fluorine Chemistry, 104, 2 173-183 (2000). One example is the reaction of the telomer ethylene iodides with sodium thioacetate, followed by hydrolysis, as shown in the following scheme:

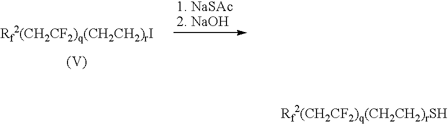

A further embodiment of the invention is a method of treating fibrous substrates to impart oil repellency and water repellency comprising applying to the surface of the substrate a core-shell emulsion polymer of the invention as described above. The aqueous emulsion of this invention is applied directly to a textile or substrate to be rendered oil- and water-repellent. The emulsion of this invention is applied alone or in admixture with dilute nonfluorinated polymers, or with other textile treatment agents or finishes. The composition can be applied at a manufacturing facility, retailer location, or prior to installation and use, or at a consumer location.

Fibrous substrates suitable for practicing the method of the invention include those as described below. The emulsion polymers of this invention are generally applied to fibrous substrates by spraying, dipping, padding, or other well-known methods. The emulsions of the invention are generally diluted with water to concentrations of from about 5 g/L to about 100 g/L, preferably from about 10 g/L to about 50 g/L, based upon the weight of the fully formulated emulsion. After excess liquid has been removed, for example by squeeze rolls, the treated fabric is dried and then cured by heating, for example, to 110° C. to 190° C., for at least 30 seconds, typically 60-180 seconds. Such curing enhances repellency and durability. While these curing conditions are typical, some commercial apparatus may operate outside these ranges because of its specific design features.

A further embodiment of the present invention is a fibrous substrate having applied to its surface a core-shell emulsion polymer of the invention as previously described. Preferably the treated substrate has a fluorine content of from about 0.05% by weight to about 0.5% by weight.

Suitable substrates include fibrous substrates. The fibrous substrates include woven and nonwoven fibers, yarns, fabrics, fabric blends, paper, leather, rugs and carpets. These are made from natural or synthetic fibers including cotton, cellulose, wool, silk, polyamide, polyester, polyolefin, polyacrylonitrile, polypropylene, rayon, nylon, aramid, and acetate. By “fabric blends” is meant fabric made of two or more types of fibers. Typically, these blends are a combination of at least one natural fiber and at least one synthetic fiber, but also can include a blend of two or more natural fibers or of two or more synthetic fibers. Carpet substrates can be dyed, pigmented, printed, or undyed. Fibers and yarns in the carpet substrates may be dyed, pigmented, printed, or undyed. Carpet substrates can be scoured or unscoured. Substrates to which it is particularly advantageous to apply the compounds of the present invention so as to impart repellency properties include polyamide (such as nylon) polyester, cotton, and blends of polyester and cotton.

The emulsions of this invention are useful in rendering the substrate surface repellent to oil and water. The repellency is durable after multiple launderings. The polymer emulsions of the present invention also have the advantage of providing such repellency while containing short chain perfluoroalkyl groups having from about 2 to about 7 carbon atoms. The emulsions of the present invention are advantageous in that they can be used under a wide variety of application conditions due to their stability.

### Test Methods

The following testing procedures were used in the Examples.

### Test Method 1—Fabric Treatment

The fabrics used were 100% Nylon and 100% polyester available from Burlington Mills, Burlington Industries, Inc., Hurt, Va., 24563. The fabric was treated with the aqueous dispersion of the core-shell emulsion polymer using a conventional pad bath (dipping) process. The prepared concentrated dispersion of the polymer emulsions of the invention were diluted with deionized water to achieve a pad bath having 3 to 10% by weight of the final emulsion in the bath to achieve a weight % fluorine designated in the Examples. A wetting agent, ALKANOL 6112 (available from E.I. du Pont de Nemours and Company, Wilmington, Del.) was also included in the bath at 0.2% by weight. The fabric was padded in the bath, and the excess liquid removed by squeeze rollers. The wet pickup was around 50-60% for nylon and 80-90% for polyester. The “wet pick up” is the weight of the bath solution of the emulsion polymer applied to the fabric, based on the dry weight of the fabric. The fabric was cured at approximately 160° C. for 2 minutes and allowed to “rest” after treatment and cure about 15-18 hours.

### Test Method 2—Water Repellency

The water repellency of a treated substrate was measured according to the DuPont Technical Laboratory Method as outlined in the TEFLON Global Specifications and Quality Control Tests information packet. The test determines the resistance of a treated substrate to wetting by aqueous liquids. Drops of water-alcohol mixtures of varying surface tensions are placed on the fabric and the extent of surface wetting is determined visually. The test provides a rough index of aqueous stain resistance. The higher the water repellency rating, the better the resistance the finished substrate has to staining by water-based substances. The composition of standard test liquids is shown in the following Table 2A. Sometimes a 1-6 scale was used for convenience. Ratings of 0.5 increments are determined by subtracting one half from the numbers in Table 1 for borderline passing of the test liquid.

TABLE 2A
Standard Test Liquids

| Water | Composition, | |
|---|---|---|
| Repellency | Isopropyl | Vol. % |
| Rating Number | Alcohol | Distilled Water |
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |
| 9 | 70 | 30 |
| 10 | 80 | 20 |
| 11 | 90 | 10 |
| 12 | 100 | 0 |

### Test Method 3—Water Repellency—Spray Rating

Water repellency was further tested by utilizing the spray test method. The treated fabric samples were tested for water repellency by following the AATCC standard Test Method No. 22-1996, conducted as follows: A fabric sample, treated with an aqueous dispersion of polymer as previously described, is conditioned for a minimum of 4 hours at 23° C.+65% relative humidity prior to testing. The fabric sample is securely fastened on a plastic/metal embroidery hoop such that the fabric is wrinkle-free. The hoop is placed on the testing stand so that the fabric is facing up. Then 250 mL of water at 80±2° F. (27±1° C.) is poured into the testing funnel allowing the water to spray onto the fabric surface. Once the water has run through the funnel, the hoop is rapped against the edge of a solid object with the fabric facing down, rotated 180 degrees and rapped again. The spotted or wetted surface is compared with the AATCC standards found in the AATCC Technical Manual. The more wet the surface, the lower the number and the poorer the repellency. A 100 denotes no wetting, a 90 denotes slight wetting (three small spots), an 80 denotes wetting signified by several (10) spots at the spray points, a 70 denotes partial wetting of the upper fabric surface, a 50 denotes wetting of the entire upper fabric surface, and a 0 denotes complete wetting of the lower and upper fabric surface. A rating of 15, 25, 35, 45, 55, 60, 65, 75 or 85 indicates performance intermediate between the above-described rankings.

### Test Method 4—Oil Repellency

The treated fabric samples were tested for oil repellency by a modification of AATCC standard Test Method No. 118, conducted as follows: A fabric sample, treated with an aqueous dispersion of polymer as previously described, is conditioned for a minimum of 4 hours at 23° C.+65% relative humidity prior to testing. A series of organic liquids, identified below in Table 2, are then applied drop wise to the fabric samples. Beginning with the lowest numbered test liquid (Repellency Rating No. 1), one drop (approximately 5 mm in diameter or 0.05 mL volume) is placed on each of three locations at least 5 mm apart. The drops are observed for 30 seconds. If, at the end of this period, two of the three drops are still spherical in shape with no wicking around the drops, three drops of the next highest numbered liquid are placed on adjacent sites and similarly observed for 30 seconds. The procedure is continued until one of the test liquids results in two of the three drops failing to remain spherical to hemispherical, or wetting or wicking occurs.

The oil repellency rating of the fabric is the highest numbered test liquid for which two of the three drops remained spherical to hemispherical, with no wicking for 30 seconds. In general, treated fabrics with a rating of 6 or more are considered good to excellent; fabrics having a rating of one or greater can be used in certain applications. Ratings of 0.5 increments are determined by subtracting one-half from the number in Table 2B for borderline passing of the text liquid.

TABLE 2B
Oil Repellency Test Liquids

| Oil | |
|---|---|
| Repellency | |
| Rating | |
| Number | Test Solution |
| 1 | NUJOL Purified Mineral Oil |
| 2 | 65/35 Nujol/n-hexadecane by volume at |
| | 21° C. |
| 3 | n-hexadecane |
| 4 | n-tetradecane |
| 5 | n-dodecane |
| 6 | n-decane |
| 7 | n-octane |
| 8 | n-heptane |

Note: NUJOL is a trademark of Plough, Inc., for a mineral oil having a Saybolt viscosity of 360/390 at 38° C. and a specific gravity of 0.880/0.900 at 15° C.

### Test Method 5—Wash Durability

The fabric samples were laundered according to International Standard specifies domestic washing procedure for textile testing. Fabric samples are loaded into a horizontal drum, front-loading type (Type A, WASCATOR FOM 71 MP-Lab) of automatic washing machine with a ballast load to give a total dry load of 4 lb. A commercial detergent is added (AATCC 1993 standard Reference Detergent WOB) and the washer programmed with high water level with warm water (105° F., 41° C.), 15 minutes normal wash cycle followed by 2 times 13 minutes rinse and then 2 minutes spin dry. The sample and ballast are washed a designated number of times (5HW for 5 washes, 20HW for 20 washes etc.). After washing is complete, the wet fabric samples are dried in air, then ironed with a flatbed press at a surface temperature of 135-160° C., seconds on each side.

### Materials

The following materials were used in the Examples.

Table 3 is a glossary of abbreviations, trademarked or branded materials used in the examples.

TABLE 3
Glossary of Materials

| Descriptor | Generic name/structure | Source |
|---|---|---|
| ARMEEN | Octadecylamine | Akzo Nobel, |
| DM18D | | Chicago, IL |
| ETHOX TDA-5 | tridecyl alcohol 5-ethylene | Ethox Chemicals, |
| | oxide adduct | Greenville, SC |
| ETHOQUAD | Methyl poly(oxyethylene)-15 | Akzo Nobel, |
| 18/25 | octadecyl ammonium | Chicago, IL |
| | chloride | |
| 7-EO | poly(oxyethylene)-7 | |
| methacrylate | methacrylate | |
| MAM | N-methylol acrylamide | Aldrich Chemical Co, |
| | | Milwaukee, WI |
| HEMA | 2-hydroxyethyl methacrylate | Aldrich Chemical Co, |
| DDM | dodecyl mercaptan | Aldrich Chemical Co, |
| DPG | dipropylene glycol | Aldrich Chemical Co, |
| VAZO 56 WSP | 2,2′-azobis(2- | E. I. du Pont |
| | methylpropionamidine) | de Nemours |
| | dihydrochloride | and Company, |
| | | Wilmington, DE |
| SUPRALATE | sodium alkyl sulfate mixture | Witco Corporation, |
| WAQE | | Greenwich, CN |

### Compound A6

Ethylene (25 g) was introduced to an autoclave charged with C₄F₉CH₂CF₂I (217 g) and d-(+)-limonene (1 g), and the reactor heated at 240° C. for 12 h. The product was isolated by vacuum distillation to provide C₄F₉CH₂CF₂CH₂CH₂I.

Fuming sulfuric acid (70 mL) was added slowly to 50 g of C₄F₉CH₂CF₂CH₂CH₂I and mixture was stirred at 60° C. for 1.5 h. The reaction was quenched with ice-cold 1.5 weight % Na₂SO₃ aqueous solution and heated at 95° C. for 0.5 h. The bottom layer was separated and washed with 10 weight % aqueous sodium acetate and distilled to provide C₄F₉CH₂CF₂CH₂CH₂OH (compound A6): bp 54-57° C. at 2 mmHg (267 Pascals).

A6-methacrylate

p-Toluene sulfonic acid (p-TSA, 2.82 g, 0.0148 mol), methylhydroquinone (MEHQ, 420 mg), compound A6 (120 g) and cyclohexane (121 mL) were combined in a flask equipped with Dean Stark trap. The reaction mixture was heated to 85° C., methacrylic acid (39.23 mL) was added, and heating continued for 24 h. The Dean Stark trap was replaced with a short path distillation column, deionized (DI) water was added to the reaction mixture, followed by distillation of cyclohexane. The reaction mixture was cooled to about 50° C. The bottom layer was placed in a separatory funnel, washed with 10% sodium bicarbonate solution, dried over anhydrous MgSO₄, and the solvent evaporated under reduced pressure to provide C₄F₉CH₂CF₂CH₂CH₂O—C(O)—C(CH₃)═CH₂ (130 g, 89% yield): bp 47-50° C. at 0.4 mm Hg (532 Pascals); ¹H NMR (CDCl₃, 400 MHz): 6.10 (1H, m), 5.59 (1H, m), 4.39 (2H, t, J=6.0 Hz), 2.85-2.69 (2H, m), 2.43 (2H, t-t, J1=16.5 Hz, J2=6 Hz), 1.94 (3H, m); MS: 397 (M⁺+1).

### Compound A11

Ethylene (15 g) was introduced to an autoclave charged with C₆F₁₃CH₂CF₂I (170 g) and d-(+)-limonene (1 g), and then the reactor was heated at 240° C. for 12 h. Product was isolated by vacuum distillation to provide C₆F₁₃CH₂CF₂CH₂CH₂I.

Fuming sulfuric acid (129 mL) was added slowly to C₆F₁₃CH₂CF₂CH₂CH₂I (112 g). The mixture was stirred at 60° C. for 1.5 h.

Then the reaction was quenched with ice-cold 1.5 weight % aqueous Na₂SO₃ and heated at 95° C. for 0.5 h. The bottom layer was separated and washed with 10 weight % sodium acetate aqueous solution and distilled to provide compound A11: mp 38° C.

A11-acrylate

p-Toluene sulfonic acid (1.07 g, 0.0056 mol), methylhydroquinone (160 mg), compound A11 (60 g, 0.14 mol) and cyclohexane (46 mL) were combined in a flask equipped with Dean Stark trap. The reaction mixture was heated to 85° C., acrylic acid (12 mL) was added and heating continued for 24 h. The Dean Stark trap was replaced with a short path distillation column, deionized water was added and the cyclohexane distilled. The reaction mixture was cooled to about 50° C., transferred to a separatory funnel, and washed with 10% sodium bicarbonate solution, dried over anhydrous MgSO₄, and concentrated to provide C₆F₁₃CH₂CF₂CH₂CH₂O—C(O)—CH═CH₂ (64 g, 95% yield): bp 55-57° C. at 0.2 mm Hg (266 Pascals); ¹H NMR (CDCl₃, 400 MHz) 6.42 (1H, d-d, J1=17.3 Hz, J2=1.4 Hz), 6.1 (1H, d-d, J1=17.3 Hz, J2=10.5 Hz), 5.87 (1H, d-d, J1=10.5 Hz, J2=1.4 Hz), 4.40 (2H, t, J=6.4 Hz), 2.86-2.48 (2H, m), 2.42 (2H, t-t, J1=16.7 Hz, J2=6.0 Hz); MS 483 (M⁺+1).

A11-methacrylate

Compound A11 was treated with methacrylic acid in a similar manner as described for the A11-acrylate formation to provide C₆F₁₃CH₂CF₂CH₂CH₂O—C(O)—C(CH₃)═CH₂ (62 g, 89% yield).

A3-acrylate and A3-methacrylate

C₆F₁₃CH₂CH₂O—C(O)—CH═CH₂ and C₆F₁₃CH₂CH₂O—C(O)—C(CH₃)═CH₂ were prepared from 1H,1H,2H,2H-perfluoro-1-octanol (Aldrich Chemical Co., Milwaukee, Wis.) using procedures similar to compounds A11-acrylate and A11-methacrylate described above.

### Compound A12

Ethylene (56 g) was introduced to an autoclave charged with C₆F₁₃(CH₂CF₂)₂I (714 g) and d-(+)-limonene (3.2 g), and the reactor heated at 240° C. for 12 h. Product was isolated by vacuum distillation to provide C₆F₁₃(CH₂CF₂)₂CH₂CH₂I.

C₆F₁₃(CH₂CF₂)₂CH₂CH₂I (111 g) and N-methylformamide (81 mL) were heated to 150° C. for 26 h. The reaction was cooled to 100° C., followed by the addition of water to separate the crude ester. Ethyl alcohol (21 mL) and p-Toluene sulfonic acid (0.7 g) were added to the crude ester, and the reaction was stirred at 70° C. for 15 min. Ethyl formate and ethyl alcohol were removed by distillation and the resulting crude alcohol was dissolved in ether, washed with aqueous sodium sulfite, water, and brine in turn, and dried over magnesium sulfate. The product was distilled under vacuum to provide compound A12: mp 42° C.

A12-acrylate

p-Toluene sulfonic acid (0.29 g), methylhydroquinone (0.043 g), compound A12 (15 g, 0.031 mol), and cyclohexane (10 mL) were combined in a flask equipped with a Dean Stark trap. The reaction mixture was heated to 85° C., acrylic acid (2.6 mL, 0.038 mol) was added, and heating continued for 24 h. The Dean Stark trap was replaced with a short path distillation column. Deionized water was added and the cyclohexane distilled. The reaction mixture was cooled to about 50° C., the bottom layer transferred to a separatory funnel, washed with 10% sodium bicarbonate solution, dried over anhydrous MgSO₄, and concentrated to provide C₆F₁₃(CH₂CF₂)₂CH₂CH₂O—C(O)—CH═CH₂ (15.5 g, 93% yield).

A12-methacrylate

Compound A12 was treated with methacrylic acid in a similar manner as described for the A12-acrylate formation to provide C₆F₁₃(CH₂CF₂)₂CH₂CH₂O—C(O)—C(CH₃)═CH₂ (15.5 g, 91% yield).

### Compound B3

C₃F₇OCF₂CF₂I (100 g, 0.24 mol) and benzoyl peroxide (3 g) were charged under nitrogen into a vessel. A series of three vacuum/nitrogen gas sequences was then executed at −50° C. and ethylene (18 g, 0.64 mol) was introduced. The vessel was heated for 24 h at 110° C. The autoclave was cooled to 0° C. and opened after degassing. Then the product was collected in a bottle. The product was distilled to provide C₃F₇OCF₂CF₂CH₂CH₂I (80 g, 80% yield): bp 56˜60° C. at 25 mm Hg (3325 Pa).

A mixture of C₃F₇OCF₂CF₂CH₂CH₂I, (300 g, 0.68 mol) and N-methyl-formamide (300 mL), was heated to 150° C. for 26 h. Then the reaction was cooled to 100° C., followed by the addition of water to separate the crude ester. Ethyl alcohol (77 mL) and p-toluene sulfonic acid (2.59 g) were added to the crude ester, and the reaction was stirred at 70° C. for 15 minutes. Then ethyl formate and ethyl alcohol were distilled out to give a crude product. The crude product was dissolved in ether, washed with aqueous sodium sulfite, water, and brine in turn, then dried over magnesium sulfate. The product was then distilled to provide C₃F₇OCF₂CF₂CH₂CH₂OH (B3, 199 g, 85% yield): bp 71˜73° C. at 40 mmHg (5320 Pa).

B3-methacylate

p-Toluene sulfonic acid (1.14 g), methylhydroquinone (0.086 g), compound B3 (50 g), and cyclohexane (49 mL) were combined in a flask equipped with a Dean Stark trap. The mixture was heated to 85° C., followed by addition of methacrylic acid (15.9 mL), and the heating continued 24 h. The Dean Stark trap was replaced with a short path distillation column, deionized water (50 mL) was added, followed by distillation of cyclohexane. The reaction mixture was cooled to about 50° C. and the bottom layer transferred to a separatory funnel, washed with 10% aqueous sodium bicarbonate, dried over anhydrous MgSO₄, and concentrated to provide C₃F₇OCF₂CF₂CH₂CH₂O—C(O)—C(CH₃)═CH₂ (56 g, 94% yield): ¹H NMR (CDCl₃, 400 MHz) 6.13 (1H, m), 5.61 (1H, m), 4.43 (2H, t, J=6 Hz), 2.44 (2H, t-t, J1=17 Hz, J2=6 Hz), 1.19 (3H, s); MS 399 (M⁺+1).

### EXAMPLES

These examples are illustrative and are not to be read as limiting the scope of the invention as it is defined by the appended claims.

### Example 1

This example illustrates the formation of a core-shell emulsion polymer of the invention using a two-stage polymerization process. The compositions of Emulsions 1 and 2 used in forming the core and shell, respectively, are listed in Table 4.

TABLE 4
Core and Shell Emulsion Composition for Example 1

| Material | Emulsion 1, g | Emulsion 2, g |
|---|---|---|
| ETHOX TDA-5 | 4.81 | 1.70 |
| ETHOQUAD | 1.19 | 1.22 |
| 18/25 | | |
| A3-methacylate^{a} | 0 | 21.03 |
| Poly(oxyethylene)- | 1.19 | 0.44 |
| 7 methacrylate | | |
| stearyl | 22.0 | 5.99 |
| methacrylate | | |
| N-methylol | 1.19 | 0.51 |
| acrylamide | | |
| 2-hydroxyethyl | 0.64 | 0.24 |
| methacrylate | | |
| Dodecyl | 0.35 | 0.15 |
| mercaptan | | |
| Dipropylene glycol | 18.18 | 7.18 |
| Vinylidene | 22.0^{b} | 0.2^{b} |
| chloride | | |
| Deionized water | 89.9 | 35.4 |

^{a}fluorinated monomer prepared as described under “Materials”;
^{b}added to reactor

The components of Emulsion 1, less the vinylidene chloride, and with the deionized water being preheated to 50-60° C., was sonified in a plastic beaker with a sonicator (Model W-370 from Heat Systems Ultrasonics, Inc.) for 2 two-minute intervals, keeping the temperature below 70° C., to provide an emulsion. The emulsion was transferred to a 500 mL four-neck reactor equipped with mechanic stir, thermocouple thermometer and chiller condenser (−5 to −10° C.). The emulsion was rinsed into the reactor with hot deionized water (19.5 g) and purged with nitrogen for about 30 min until the temperature was below 30° C. The vinylidene chloride was then added to the reaction flask and mixed for 5 min. VAZO 56 WSP initiator (0.26 g, E.I. du Pont de Nemours and Company, Wilmington, Del.) dissolved in 10.75 g of deionized water was added and the mixture was heated to 50° C. within 0.5 h and maintained for 4 h, and then cooled to room temperature (ambient temperature) to provide the core polymer emulsion.

The components of Emulsion 2, less the vinylidene chloride, and with the water being preheated to 50-60° C., was sonified in a plastic beaker as described above, to provide an emulsion. The emulsion was purged with nitrogen for about 30 min and then added to the reactor containing the core polymer emulsion, along with the vinylidene chloride. VAZO 56 WSP initiator (0.13 g) dissolved in deionized water (4.5 g) was added and the mixture was heated to 50° C. within 0.5 h and maintained for 8 h and then cooled to ambient temperature. Deionized water (42 g) solution containing SUPRALATE WAQE surfactant (0.6 g, available from Witco Corporation, Greenwich, Conn.) was mixed with the product at ambient temperature. The resulting core-shell emulsion polymer was filtered through a milk filter and weighed 319.8 g with a solids content of 24.1%. Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6A, 6B, and 6C.

### Comparative Example A

This comparative example illustrates the formation of a mixture of two emulsions of the same composition as the core and shell emulsions of Table 4 (Example 1), but with a one-stage polymerization, to provide a blend of emulsions 1 and 2 without a core-shell structure. Emulsions 1 and 2 having compositions of Table 4 were prepared and added to a 500 mL four-neck reactor equipped with mechanic stir, thermocouple thermometer and chiller condenser (−5 to −10° C.). The emulsions were rinsed into the flask with 28 g of hot deionized water and purged with nitrogen for 30 min until the temperature was below 30° C. Vinylidene chloride (22 g) was then added and mixed for 5 minutes. “VAZO” 56 WSP initiator (0.37 g), available from E.I. du Pont de Nemours and Company, Wilmington, Del., dissolved in deionized water (14.9 g) was added and the mixture was heated to 50° C. within 0.5 h and maintained for 8 h. Deionized water (42 g) solution containing SUPRALATE WAQE surfactant (0.6 g), available from Witco Corporation, Greenwich, Conn., was mixed with the product at ambient temperature. The resulting polymer latex was filtered through a milk filter and weighed 320 g with solids content of 22.5%.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6A.

### Comparative Example B

This comparative example illustrates the formation of a random polymer blend of two separate emulsions, each prepared by a single stage emulsion polymerization. One emulsion contained a fluorinated monomer (Emulsion 1 in Table 5A), and the other emulsion was an extender having no fluorinated monomer (Emulsion 2 in Table 5A). The polymerized emulsions were then blended in a 1:1 ratio to give an emulsion blend of a similar overall formulation to Example 1. Comparative Example B is not identical to Emulsions 1 and 2 of Example 1 because that formulation would not form a stable emulsion. The composition of the two separate emulsions is listed in Table 5A.

TABLE 5A
Emulsion Composition for Comparative Example B

| Material | Emulsion 1, g | Emulsion 2, g |
|---|---|---|
| ETHOX TDA-5 | 2.56 | 4.6 |
| ETHOQUAD | 1.80 | 3.2 |
| 18/25 | | |
| A3-methacylate^{a} | 25.02 | 0 |
| Poly(oxyethylene)- | 0.7 | 1.25 |
| 7 methacrylate | | |
| Stearyl | 6.63 | 30.0 |
| methacrylate | | |
| N-methylol | 0.74 | 1.25 |
| acrylamide | | |
| 2-hydroxyethyl | 0.37 | 0.68 |
| methacrylate | | |
| Dodecyl | 0.19 | 0.34 |
| mercaptan | | |
| Dipropylene glycol | 10.9 | 19.36 |
| Vinylidene | 2.2^{b} | 30.0^{b} |
| chloride | | |
| Deionized water | 47.2 | 96.0 |

^{a}fluorinated monomer prepared as described under “Materials”
^{b}added to reactor

Emulsion 1 was prepared, minus the vinylidene chloride, and added to a 500 mL four-neck reactor equipped with mechanic stir, thermocouple thermometer and chiller condenser (−5 to −10° C.). The emulsion was rinsed into the flask with hot deionized water (6.4 g) and purged with nitrogen for 30 min until the temperature was below 30° C. The vinylidene chloride was then added and mixed for 5 minutes. VAZO 56 WSP initiator (0.19 g), available from E.I. du Pont de Nemours and Company, Wilmington, Del., dissolved in deionized water (8.6 g) was added and the mixture was heated to 50° C. within 0.5 h and maintained for 8 h. Deionized water (27.2 g) solution containing SUPRALATE WAQE surfactant (0.22 g), available from Witco Corporation, Greenwich, Conn., was mixed with the product at ambient temperature. The resulting polymer latex was filtered through a milk filter and weighed 130.67 g with solids content of 25.1%.

Emulsion 2 was prepared, minus the vinylidene chloride, and added to a 500 mL four-neck reactor equipped with mechanic stir, thermocouple thermometer and chiller condenser (−5 to −10° C.). The emulsion was rinsed into the flask with hot deionized water (10 g) and purged with nitrogen for 30 min until the temperature was below 30° C. The vinylidene chloride was then added and mixed for 5 minutes. VAZO 56 WSP initiator (0.34 g) dissolved in deionized water (10 g) was added and the mixture was heated to 50° C. within 0.5 h and maintained for 8 h. Deionized water (12.4 g) solution containing SUPRALATE WAQE surfactant (0.46 g) was mixed with the product at ambient temperature. The resulting polymer latex was filtered through a milk filter and weighed 206 g with solids content of 27.9%.

Emulsion 1 and 2 were blended in a 1:1 weight ratio to provide the emulsion polymer of Comparative Example B having a final weight % of fluorinated monomer of 32.9% based on solids.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6A.

### Comparative Example C

This comparative example illustrates the formation of a core-shell emulsion polymer as disclosed in Example 1 of Lee, et al, U.S. Pat. No. 6,790,898, wherein styrene was used as a monomer in the core, and 3,3,4,4,5,5,6,6,7,7,8,8,9,9,10,10,10-heptadecafluorodecyl acrylate was the fluorinated monomer in the shell.

The compositions of emulsion 1 and 2 used in forming the core and shell, respectively, are listed in Table 5B.

TABLE 5B
Emulsion Composition for Comparative Example C

| Material | Emulsion 1, g | Emulsion 2, g |
|---|---|---|
| Stearyl trimethyl | 1.05 | 1.12 |
| ammonium | | |
| chloride, 28% | | |
| solution in water | | |
| Fluorinated | 0 | 3.98 |
| acrylate^{a} | | |
| Styrene | 8 | 0 |
| Dodecyl | 0.21 | 0 |
| mercaptan | | |
| Deionized water | 79.95 | 36.07 |

^{a}3,3,4,4,5,5,6,6,7,7,8,8,9,9,10,10,10-heptadecafluorodecyl acrylate

Emulsion 1 was prepared and added to a 250 mL four-neck reactor equipped with mechanic stir, thermocouple thermometer and chiller condenser (1.5° C.). The emulsion purged with nitrogen for 30 min. The mixture was heated to 65° C. within 0.5 h and then “VAZO” 56 WSP initiator (0.11 g), available from E.I. du Pont de Nemours and Company, Wilmington, Del., dissolved in deionized water (20 g) was added and the reaction maintained at 65° C. for 1 h.

Emulsion 2 was prepared and while remaining in the beaker, purged for 30 min. A syringe pump with a flow rate of 0.167 mL/min was used to add emulsion 2 to the reactor over 4 h. After 4 h, polymerization continued for another 4 h at 65° C. The reaction cooled to ambient temperature. The resulting polymer was filtered through a milk filter and weighed 132.3 g with solids content of 8.1%.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6B, and 6C.

### Comparative Example D

This comparative example illustrates the formation of a core-shell emulsion polymer as disclosed in Example 1 of Lee, et al, U.S. Pat. No. 6,790,898, wherein styrene was used as a monomer in the core, but the fluorinated monomer in the shell 3,3,4,4,5,5,6,6,7,7,8,8,9,9,10,10,10-heptadecafluorodecyl acrylate was replaced with the C6 homolog, that is the A3-methacylate used in Example 1 and prepared as described in “Materials”.

The compositions of emulsion 1 and 2 used in forming the core and shell, respectively, are listed in Table 5C. The procedure was identical to that for Comparative Example C above, and provided 4.02 g with a solids content of 7.89%.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6B, and 6C.

TABLE 5C
Emulsion Composition for Comparative Example D

| Material | Emulsion 1, g | Emulsion 2, g |
|---|---|---|
| Stearyl trimethyl | 1.05 | 1.12 |
| ammonium chloride, | | |
| 28% solution in water | | |
| A3-methacylate^{a} | 0 | 3.98 |
| Styrene | 8 | 0 |
| Dodecyl mercaptan | 0.21 | 0 |
| Deionized water | 79.95 | 36.07 |

^{a}fluorinated monomer prepared as described under “Materials”

### Comparative Example E

This comparative example illustrates the formation of a mixture of two emulsions of similar compositions as Example 1, Table 4, but with the replacement of vinylidene chloride with styrene. The compositions of Emulsions 1 and 2 used in forming the core and shell, respectively, are listed in Table 5D.

TABLE 5D
Core and Shell Emulsion Composition for Comparative Example E

| Material | Emulsion 1, g | Emulsion 2, g |
|---|---|---|
| ETHOX TDA-5 | 4.86 | 1.68 |
| ETHOQUAD | 1.22 | 1.22 |
| 18/25 | | |
| C6- | 0 | 21.02 |
| methacrylate^{a} | | |
| 7-EO | 1.18 | 0.47 |
| methacrylate | | |
| Stearyl | 22.06 | 6.03 |
| methacrylate | | |
| N-methylol | 1.21 | 0.44 |
| acrylamide | | |
| 2-hydroxyethyl | 0.65 | 0.23 |
| methacrylate | | |
| Dodecyl | 0.39 | 0.15 |
| mercaptan | | |
| Dipropylene | 18.23 | 7.19 |
| glycol | | |
| Styrene | 21.99^{b} | 0 |
| Deionized | 89.93 | 35.37 |
| water | | |

^{a}fluorinated monomer prepared as described under “Materials”
^{b}added to reactor

Emulsion 1 was prepared and added to a 500 mL four-neck reactor equipped with mechanic stir, thermocouple thermometer and chiller condenser (1.5° C.). The emulsion purged with nitrogen for 30 min. After 30 min, styrene was added to the reactor, and stirred for 10 min. “VAZO” 56 WSP initiator (0.29 g), available from E.I. du Pont de Nemours and Company, Wilmington, Del., dissolved in deionized water (10.76 g) was added and then the mixture was heated to 50° C. within 0.5 h. The reaction maintained at 50° C. for 4 h.

Emulsion 2 was prepared and while remaining in the beaker, purged for 30 min. Emulsion 2 was added to the reaction flask and “VAZO” 56 WSP initiator (0.12 g) dissolved in deionized water (4.22 g) was added, the reaction maintained at 50° C. for 8 h. The reaction cooled to ambient temperature. A deionized water (41.8 g) solution containing SUPRALATE WAQE surfactant (0.59 g, available from Witco Corporation, Greenwich, Conn.) was mixed with the product at ambient temperature. The resulting core-shell emulsion polymer was filtered through a milk filter and weighed 301.02 g with a solids content of 24.5%.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6B, and 6C.

### Comparative Example F

This comparative example illustrates the formation of a mixture of two emulsions of similar compositions as Example 1 Table 4, but with the replacement of vinylidene chloride with methyl methacrylate. The compositions of Emulsions 1 and 2 used in forming the core and shell, respectively, are listed in Table 5E.

TABLE 5E
Core and Shell Emulsion Composition for Comparative Example F

| Material | Emulsion 1, g | Emulsion 2, g |
|---|---|---|
| ETHOX TDA-5 | 4.81 | 1.74 |
| ETHOQUAD | 1.21 | 1.21 |
| 18/25 | | |
| C6- | 0 | 20.97 |
| methacrylate^{a} | | |
| 7-EO | 1.2 | 0.47 |
| methacrylate | | |
| Stearyl | 22 | 5.99 |
| methacrylate | | |
| N-methylol | 1.25 | 0.46 |
| acrylamide | | |
| 2-hydroxyethyl | 0.66 | 0.28 |
| methacrylate | | |
| Dodecyl | 0.34 | 0.13 |
| mercaptan | | |
| Dipropylene | 18.19 | 7.21 |
| glycol | | |
| Methyl | 22^{b} | 0 |
| methacrylate | | |
| Deionized | 89.9 | 35.39 |
| water | | |

^{a}fluorinated monomer prepared as described under “Materials”
^{b}added to reactor

Emulsion 1 was prepared and added to a 500 mL four-neck reactor equipped with mechanic stir, thermocouple thermometer and chiller condenser (1.5° C.). The emulsion purged with nitrogen for 30 min. After 30 min, methyl methacrylate was added to the reactor, and stirred for 10 min. “VAZO” 56 WSP initiator (0.28 g), E.I. du Pont de Nemours and Company, Wilmington, Del., dissolved in deionized water (10.71 g) was added and then the mixture was heated to 50° C. within 0.5 h. The reaction maintained at 50° C. for 4 h.

Emulsion 2 was prepared and while remaining in the beaker, purged for 30 min. Emulsion 2 was added to the reaction flask and “VAZO” 56 WSP initiator (0.12 g) dissolved in deionized water (4.24 g) was added, the reaction maintained at 50° C. for 8 h. The reaction cooled to ambient temperature. A deionized water (41.8 g) solution containing SUPRALATE WAQE surfactant (0.60 g, available from Witco Corporation, Greenwich, Conn.) was mixed with the product at ambient temperature.

Nylon fabric and polyester were treated with the copolymer aqueous dispersion using a conventional pad bath (dipping) process as described in Test Method 1. Water, spray and oil repellency tests were conducted on the treated fabric according to Test Methods 2-5 described above. The results are listed in Tables 6B, and 6C.

TABLE 6A
Fabric Repellency

| | | | Oil | | | Water | | | Spray | | |
|---|---|---|---|---|---|---|---|---|---|---|---|
| Example | % F^{a} | Fabric | Initial | 5 HW | 20 HW | initial | 5 HW | 20 HW | initial | 5 HW | 20 HW |
| 1 | 0.12 | Nylon | 6.5 | 4 | 4 | 12 | 9 | 8.5 | 100 | 90 | 80 |
| Comparative A | 0.12 | Nylon | 1 | 0 | 0 | 7 | 6 | 5 | 75 | 65 | 50 |
| Comparative B | 0.153 | Nylon | 5 | 2 | 2 | 11 | 8 | 6 | 100 | 75 | 55 |
| 1 | 0.12 | Polyester | 5.5 | 5.5 | 4.5 | 10.5 | 10.5 | 9.5 | 100 | 100 | 100 |
| Comparative A | 0.12 | Polyester | 0.5 | 0.5 | 0 | 6.5 | 6.5 | 6 | 80 | 75 | 70 |

^{a}weight % fluorine in bath

The results indicate that fabrics treated with the core-shell emulsion polymer of Example 1, at the same % by weight fluorine as Comparative Example A, exhibits much superior oil, water and spray resistance on nylon and polyester fabrics. Comparative Example A was a non-core-shell mixture of emulsions of identical composition to the core and shell compositions of Example 1. This indicated that the core-shell structure derived from the two-stage polymerization provided a polymer emulsion having much improved properties as a treating agent for fabrics over that of a mixture of emulsions provided by a single-stage polymerization process.

The results indicated that fabrics treated with the core-shell emulsion polymer of Example 1, at a lower % by weight fluorine as Comparative Example B, exhibited much superior oil, water and spray resistance on nylon fabric. Comparative Example B was a blend of an emulsion polymer derived from random emulsion polymerization of a composition similar to the shell composition of Example 1 and a random polymer emulsion similar to the core composition of Example 1. The Comparative Example B blend had a similar overall composition as Example 1 with slightly higher fluorinated monomer content, 33% by weight versus 27.8% by weight for the Example 1, but without the core-shell structure. The fabric treated with the Comparative Example B blend exhibited repellency properties comparable to Example 1, but did not exhibit the durability of Example 1, indicating that the core-shell structure allowed better performance characteristics at lower levels of fluorinated monomer over a longer time period.

The results for Example 1 and Comparative Examples C, D, E and F are listed in Tables 6B and 6C.

TABLE 6B
Repellency on Nylon

| | | Oil | | Water | | Spray | |
|---|---|---|---|---|---|---|---|
| Example | % F^{a} | Initial | 5 HW | Initial | 5 HW | Initial | 5 HW |
| 1 | 0.11 | 6− | 3 | 11− | 9− | 100 | 70 |
| Comparative C | 0.12 | 0 | 0 | 4− | 1− | 70 | 60 |
| Comparative D | 0.11 | 0 | 0 | 4 | 1− | 70 | 60 |
| Comparative E | 0.11 | 4 | 3− | 10 | 8− | 100 | 75 |
| Comparative F | 0.11 | 5− | 2− | 10 | 5 | 95 | 80 |

^{a}weight % fluorine in bath

TABLE 6C
Repellency on Polyester

| | | Oil | | Water | | Spray | |
|---|---|---|---|---|---|---|---|
| Example | % F^{a} | Initial | 5 HW | Initial | 5 HW | Initial | 5 HW |
| 1 | 0.11 | 5 | 5− | 11− | 10− | 100 | 95 |
| Comparative C | 0.12 | 5− | 1− | 10 | 4− | 95 | 70 |
| Comparative D | 0.11 | 2 | 0 | 7 | 4− | 95 | 80 |
| Comparative E | 0.11 | 2 | 2− | 8 | 8− | 85 | 90 |
| Comparative F | 0.11 | 4 | 0 | 10 | 3 | 100 | 70 |

^{a}weight % fluorine in bath

Comparative Example C was a core-shell emulsion polymer as disclosed in Example 1 of Lee, et al, U.S. Pat. No. 6,790,898, wherein styrene was used as a monomer in the core, and 3,3,4,4,5,5,6,6,7,7,8,8,9,9,10,10,10-heptadecafluorodecyl acrylate was the fluorinated monomer in the shell. Comparison of Example 1 of the invention with Comparative Example C, at similar % F in the bath, indicated that Comparative Example C exhibited substantially lower oil-, water- and spray-repellency on Nylon at both initial and 5 HW trials. On polyester Comparative Example C exhibited similar initial oil-, water- and spray-repellency; but exhibited substantially lower oil-, water- and spray-repellency in the 5 HW trial, than that of Example 1; indicating Comparative Example C exhibited poor durability.

Comparative Example D was a core-shell emulsion polymer as disclosed in Example 1 of Lee, et al, U.S. Pat. No. 6,790,898, wherein styrene was used as a monomer in the core, but the fluorinated monomer in the shell 3,3,4,4,5,5,6,6,7,7,8,8,9,9,10,10,10-heptadecafluorodecyl acrylate was replaced with the C6 homolog, that is the A3-methacylate used in Example 1. Thus comparison of Comparative Example D and Example 1 allowed comparison using the same fluorinated monomer, A3 methacrylate, in the shell, but with different monomers in the core. Comparison of Example 1 of the invention with Comparative Example D, at the same % F in the bath, indicated that comparative Example D exhibited substantially lower oil-, water- and spray-repellency on Nylon at both initial and 5 HW trials. On polyester, Comparative Example D exhibited substantially lower oil- and water-repellency at both initial and 5 HW trials; and lower spray-repellency in the 5 HW trial; than that of Example 1. This comparison indicated that using a C6 perfluorinated monomer in the core-shell system of the Lee reference, is not sufficient to impart good oil- and water-repellency. Furthermore, the composition of Example 1, of the invention disclosed herein, provided superior oil- and water-repellency; and superior durability, than that of Comparative Example D.

Comparative Example E was a core-shell emulsion polymer as disclosed in Example 1, but with the replacement of vinylidene chloride with styrene. Comparison of Example 1 of the invention with Comparative Example E, at the same % F in the bath, indicated that comparative Example E exhibited lower oil- and water-repellency on Nylon at both initial and 5 HW trials. On polyester Comparative Example E exhibited substantially lower oil- and water-repellency at both initial and 5 HW trials than that of Example 1. This indicated that core-shell polymers wherein the core comprises vinylidene chloride exhibit better oil-water-repellency than comparable core-shell polymers having styrene in the core.

Comparative Example F was a core-shell emulsion polymer as disclosed in Example 1, but with the replacement of vinylidene chloride with methyl methacrylate. Comparison of Example 1 of the invention with Comparative Example F, at the same % F in the bath, indicated that comparative Example F exhibited lower oil- and water-repellency on Nylon in the initial trial and substantially lower oil- and water-repellency in the 5 HW trial. On polyester Comparative Example F exhibited lower oil- and water-repellency in the initial trial; and substantially lower oil- and water-repellency in the 5 HW trials; than that of Example 1. This indicated that core-shell polymers wherein the core comprises vinylidene chloride exhibit better oil-water-repellency than comparable core-shell polymers having methyl methacrylate in the core; especially in the 5 HW trial. This indicated that Example 1 exhibited superior durability relative to that of Comparative Example F.

### Examples 2-5

Using the procedure of Example 1, examples 2 to 5 were prepared using the formulations listed in Tables 8 to 11 to provide the core-shell polymers listed in Table 7

TABLE 7
Core-Shell Polymers

| | | Core/shell weight |
|---|---|---|
| Example | % solids | ratio^{a} |
| 2 | 24.3 | 2.2 |
| 3 | 23.8 | 1.8 |
| 4 | 24.3 | 1.5 |
| 5 | 23.5 | 1.1 |

^{a}based on solids

TABLE 8
Core and Shell Emulsion Composition for Example 2

| Material | Emulsion 1, g | Emulsion 2, g |
|---|---|---|
| ETHOX TDA-5 | 4.77 | 1.68 |
| ETHOQUAD | 1.18 | 1.192 |
| 18/25 | | |
| A3-methacylate^{a} | 0 | 21 |
| Poly(oxyethylene)- | 1.175 | 0.464 |
| 7 methacrylate | | |
| Stearyl | 22.0 | 6.0 |
| methacrylate | | |
| N-methylol | 1.194 | 0.464 |
| acrylamide | | |
| 2-hydroxyethyl | 0.639 | 0.252 |
| methacrylate | | |
| Dodecyl | 0.338 | 0.128 |
| mercaptan | | |
| Dipropylene glycol | 18.19 | 7.16 |
| Vinylidene | 22.0^{b} | 0.2^{b} |
| chloride | | |
| Deionized water | 109 | 43.4 |

^{a}fluorinated monomer prepared as described in “Materials”
^{b}added to reactor

TABLE 9
Core and Shell Emulsion Composition for Example 3

| Material | Emulsion 1, g | Emulsion 2, g |
|---|---|---|
| ETHOX TDA-5 | 3.816 | 1.68 |
| ETHOQUAD | 0.944 | 1.192 |
| 18/25 | | |
| A3-methacylate^{a} | 0 | 21.0 |
| Poly(oxyethylene)- | 0.94 | 0.464 |
| 7 methacrylate | | |
| stearyl | 17.6 | 6.0 |
| methacrylate | | |
| N-methylol | 0.955 | 0.464 |
| acrylamide | | |
| 2-hydroxyethyl | 0.511 | 0.252 |
| methacrylate | | |
| Dodecyl | 0.270 | 0.128 |
| mercaptan | | |
| Dipropylene glycol | 14.551 | 7.16 |
| Vinylidene | 17.6^{b} | 0.2^{b} |
| chloride | | |
| Deionized water | 87 | 43.4 |

^{a}fluorinated monomer prepared as described in “Materials”
^{b}added to reactor

TABLE 10
Core and Shell Emulsion Compositions for Example 4

| | | |
|---|---|---|
| Material | Emulsion 1, g | Emulsion 2, g |

| | | |
|---|---|---|
| ETHOX TDA-5 | 3.816 | 2.02 |
| ETHOQUAD | 0.944 | 1.430 |
| 18/25 | | |
| A3-methacylate^{a} | 0 | 25.2 |
| Poly(oxyethylene)- | 0.94 | 0.557 |
| 7 methacrylate | | |
| stearyl | 17.6 | 7.2 |
| methacrylate | | |
| N-methylol | 0.955 | 0.557 |
| acrylamide | | |
| 2-hydroxyethyl | 0.511 | 0.302 |
| methacrylate | | |
| Dodecyl | 0.270 | 0.154 |
| mercaptan | | |
| Dipropylene glycol | 14.55 | 8.59 |
| Vinylidene | 17.6^{b} | 0.2^{b} |
| chloride | | |
| Deionized water | 87 | 51.0 |

^{a}fluorinated monomer prepared as described in “Materials”
^{b}added to reactor

TABLE 11
Core and Shell Emulsion Compositions for Example 5

| Material | Emulsion 1, g | Emulsion 2, g |
|---|---|---|
| ETHOX TDA-5 | 3.58 | 2.53 |
| ETHOQUAD 18/25 | 0.89 | 1.79 |
| A3-methacylate^{a} | 0 | 31.5 |
| Poly(oxyethylene)- | 0.88 | 0.70 |
| 7 methacrylate | | |
| stearyl | 16.5 | 9 |
| methacrylate | | |
| N-methylol | 0.90 | 0.70 |
| acrylamide | | |
| 2-hydroxyethyl | 0.48 | 0.38 |
| methacrylate | | |
| Dodecyl mercaptan | 0.25 | 0.19 |
| Dipropylene glycol | 13.64 | 10.74 |
| vinylidene chloride | 16.5^{b} | 0.2^{b} |
| deionized water | 81 | 64.0 |

^{a}fluorinated monomer prepared as described in “Materials”
^{b}added to reactor

Nylon fabric was treated with the copolymer aqueous dispersion of Examples 2 to 5 using a conventional pad bath (dipping) process The concentrated dispersion of the polymer emulsions of Examples 2 to 5, 3 parts, were diluted with 97 parts deionized water to achieve a pad bath having 3% by weight of emulsion in the water bath. The fabric was padded in the bath, and the excess liquid removed by squeeze rollers. A wetting agent, ALKANOL 6112, available from E.I. du Pont de Nemours and Company, Wilmington, Del., was also included in the bath at 0.2% by weight. The wet pickup was around 50-60%. The fabric was cured at approximately 160° C. for 2 minutes and allowed to “rest” after treatment and cure about 15-18 hours. Water, spray and oil repellency tests were conducted on the treated fabric according to Test Methods 2-5 described above. The results are listed in Table 12.

TABLE 12
Fabric Repellency on Nylon^{a}

| | Oil | | Water | | Spray | |
|---|---|---|---|---|---|---|
| Example | initial | 20 HW | initial | 20 HW | initial | 20 HW |
| untreated | 0 | | 0 | | 0 | |
| 2 | 4.5 | 3.5 | 10.5 | 7.5 | 100 | 90 |
| 3 | 4.5 | 2.5 | 9.5 | 7 | 100 | 80 |
| 4 | 4.5 | 3.5 | 9.5 | 6.5 | 100 | 85 |
| 5 | 5 | 1.5 | 10 | 6 | 100 | 70 |

^{a}3% loading of aqueous emulsion composition in water bath

The results indicated that emulsion polymers of Examples 2 to 5 had good oil repellency and good to excellent water and spray repellency on Nylon fabric.

### Examples 6-11

Using the procedure of Example 1, examples 6 to 11 were prepared using the various fluorinated monomers listed in Table 13.

TABLE 13
Fluorinated Monomers for Examples 6-11

| Example | Fluorinated Monomer |
|---|---|
| 6 | A11-methacylate |
| 7 | A11-acrylate |
| 8 | A6-methacrylate |
| 9 | A12-acrylate |
| 10 | A12-methacrylate |
| 11 | B3-methacylate |

A constant weight of various fluorinated monomers, prepared as described under “Materials”, was used throughout the Examples 6 to 11 to provide the filtered core-shell polymer emulsions. The compositions of Emulsions 1 and 2 used in forming the core and shell polymers are listed in Table 14.

TABLE 14
Core and Shell Emulsion Composition for Examples 6 to 11

| Material | Emulsion 1, g | Emulsion 2, g |
|---|---|---|
| ETHOX TDA-5 | 2.4 | 0.84 |
| ETHOQUAD | 0.57 | 0.59 |
| 18/25 | | |
| Fluorinated | 0 | 10.5 |
| monomer | | |
| Poly(oxyethylene)- | 0.6 | 0.25 |
| 7 methacrylate | | |
| Stearyl | 11.0 | 2.99 |
| methacrylate | | |
| N-methylol | 0.6 | 0.25 |
| acrylamide | | |
| 2-hydroxyethyl | 0.30 | 0.16 |
| methacrylate | | |
| Dodecyl | 0.17 | 0.15 |
| mercaptan | | |
| Dipropylene glycol | 9.09 | 7.18 |
| Vinylidene | 11.0^{a} | 0 |
| chloride | | |
| Deionized water | 44.8 | 17.7 |

^{a}added to reactor

The components of Emulsion 1, less the vinylidene chloride, and with the deionized water being preheated to 50-60° C., was sonified in a plastic beaker as described in Example 1. The emulsion was transferred to a 250 mL four-neck reactor equipped with mechanic stir, thermocouple thermometer and chiller condenser (−5 to −10° C.). The emulsion was rinsed into the reactor with hot deionized water (5 g) and purged with nitrogen for about 30 min until the temperature was below 30° C. The vinylidene chloride was then added to the reaction flask and mixed for 5 min. VAZO 56 WSP initiator (0.125 g), available from E.I. du Pont de Nemours and Company, Wilmington, Del., dissolved in deionized water (9.4 g) was added and the mixture was heated to 50° C. within 0.5 h and maintained for 4 h, and then cooled to ambient temperature to provide the core polymer emulsion.

The components of Emulsion 2, with the water being preheated to 50-60° C., was sonified in a plastic beaker as described above, to provide an emulsion. The emulsion was purged with nitrogen for about 30 min and then added to the reactor containing the core polymer emulsion. VAZO 56 WSP initiator (0.065 g) dissolved in deionized water (9.13 g) was added and the mixture was heated to 50° C. within 0.5 h and maintained for 8 h and then cooled to ambient temperature. Deionized water (13.7 g) solution containing SUPRALATE WAQE surfactant (0.3 g), available from Witco Corporation, Greenwich, Conn., was mixed with the product at ambient temperature. The resulting core-shell emulsion polymer was filtered through a milk filter and weighed about 141 g with a solids content of 21.8%.

Nylon fabric was treated with the copolymer aqueous dispersion using a conventional pad bath (dipping) process. The concentrated dispersion of the polymer emulsions of Examples 6 to 11 were diluted with deionized water to achieve a pad bath having 0.2 weight % fluorine. The fabric was padded in the bath, and the excess liquid removed by squeeze rollers. A wetting agent, ALKANOL 6112, available from E.I. du Pont de Nemours and Company, Wilmington, Del., was also included in the bath at 0.2% by weight. The wet pickup was about 50%. The fabric was cured at approximately 160° C. for 2 minutes and allowed to “rest” after treatment and cure about 15-18 hours. Water, spray and oil repellency tests were conducted on the treated fabric and untreated control according to Test Methods 2-5 described above. The results are listed in Table 15.

TABLE 15
Fabric Repellency on Nylon

| | Oil | | Water | | Spray | |
|---|---|---|---|---|---|---|
| Example | initial | 20 HW | initial | 20 HW | initial | 20 HW |
| Control | 0 | | 0 | | 0 | |
| 6 | 4 | 3 | 7 | 7.5 | 100 | 80 |
| 7 | 2 | 1.5 | 9.5 | 9 | 90 | 70 |
| 8 | 2 | 2 | 6 | 6 | 90 | 70 |
| 9 | 3 | 1.5 | 8 | 6.5 | 90 | 70 |
| 10 | 5 | 3 | 10 | 9.5 | 90 | 80 |

The results indicated that the emulsions of Examples 6 to 10 all exhibited good water repellency and fair to good oil repellency on Nylon fabric, with good retention of repellency after 20 washings.

Polyester fabric was treated with the copolymer aqueous dispersion using a conventional pad bath (dipping) process. The concentrated dispersion of the polymer emulsions of Examples 6 to 11 were diluted with deionized water to achieve a pad bath having 0.2 weight % fluorine. The fabric was padded in the bath, and the excess liquid removed by squeeze rollers. A wetting agent, ALKANOL 6112, available from E.I. du Pont de Nemours and Company, Wilmington, Del., was also included in the bath at 0.2% by weight. The wet pickup was about 87%. The fabric was cured at approximately 160° C. for 2 minutes and allowed to “rest” after treatment and cure about 15-18 hours. Water, spray and oil repellency tests were conducted on the treated fabric according to Test Methods 2-5 described above. The results are listed in Table 16.

TABLE 16
Fabric Repellency on Polyester

| | Oil | | | Water | | | Spray | | |
|---|---|---|---|---|---|---|---|---|---|
| Example | initial | 5 HW | 20 HW | initial | 5 HW | 20 HW | initial | 5 HW | 20 HW |
| 6 | 5 | 5 | 5 | 10 | 10 | 10 | 100 | 100 | 100 |
| 7 | 6 | 5 | 5 | 11 | 10 | 10 | 100 | 90 | 90 |
| 8 | 4 | 4 | 3.5 | 9 | 9 | 9 | 90 | 90 | 70 |
| 9 | 6 | 6 | 6 | 11 | 11 | 11 | 100 | 100 | 100 |
| 10 | 5.5 | 5 | 5 | 11 | 11 | 11 | 100 | 100 | 100 |
| 11 | 5.5 | 4 | 4 | 10 | 9 | 9 | 90 | 90 | 90 |

The results indicated that the emulsions of Examples 6 to 11 all exhibited good water repellency and good to excellent oil repellency on polyester fabric, with durability of repellency.

What is claimed is:

1. An oil- and water-repellant core-shell emulsion polymer comprising
A) a core composition, prepared from a first polymerization, comprising, on a water-free and surfactant-free basis, components (a) and (b):
(a) from about 40 to about 95% by weight of one or more monomers selected from the group consisting of styrene; alkyl substituted styrene wherein said alkyl is a linear, cyclic or branched hydrocarbon having 1 to about 18 carbons; and alkyl (meth)acrylate wherein said alkyl is a linear, cyclic or branched hydrocarbon having from about 6 to about 18 carbons; and
(b) from about 5 to about 60% by weight of one or more monomers selected from the group consisting of vinylidene chloride, vinyl chloride, and combinations thereof; and
B) a shell composition, prepared from a second polymerization in the presence of the core composition, comprising, on a water-free and surfactant-free basis, components (c) and (d):
(c) from about 50 to about 85% by weight of one or more fluorinated monomers of formula (I), (II) or (III):
(I) R_{f}¹(CH₂)ₘZ-C(O)—C(R¹)═CH₂
(II) R_{f}²(CH₂CF₂)_{q}(CH₂CH₂)ᵣZ-C(O)—C(R¹)═CH₂
(III) R_{f}³⁰(CF₂CF₂)_{q}(CH₂CH₂)ᵣZ-C(O)—C(R¹)═CH₂
wherein
m is an integer of 1 to about 6;
q and r are each independently an integer of 1 to about 3;
R¹ is hydrogen, Cl, F or CH₃;
Z is —O—, —NH— or —S—;
R_{f}¹ is a linear or branched perfluoroalkyl group having 4 or 6 carbon atoms;
R_{f}² is a linear or branched perfluoroalkyl group having from about 4 to about 6 carbon atoms; and
R_{f}³ is a linear or branched perfluoroalkyl group having from about 2 to about 7 carbon atoms optionally interrupted by one, two or three ether oxygen atoms; and
(d) from about 15 to about 50% by weight of monomers selected from the group consisting of styrene; alkyl substituted styrene wherein said alkyl is a linear, cyclic or branched hydrocarbon having 1 to 18 carbons; and alkyl (meth)acrylate wherein said alkyl is a linear, cyclic or branched hydrocarbon having 6 to 18 carbons;
provided that i) the core composition comprises from about 20 to about 75% by weight of the polymer; ii) when R_{f}¹ or R_{f}² has 4 carbon atoms, R¹ is CH₃; and iii) when R_{f}³ has 2 or 3 carbon atoms, R¹ is CH₃.

2. The emulsion polymer of claim 1 wherein the core composition further comprises component (e):
(e) from about 0.5 to about 10% by weight of one more monomers selected from the group consisting of 2- and 4-chloromethyl styrene, vinyl acetate, N-methyloyl methacrylamide, N-methyloyl acrylamide, and monomers of the formula:
R²—(OCH₂CH₂)ₐ—O—C(O)—C(R)═CH₂
wherein a is 1 to about 10, R is H or —CH₃, and R² is hydrogen, C₁-C₄ alkyl or —C(O)—C(R)═CH₂.

3. The emulsion polymer of claim 1 wherein component (c) is the fluorinated monomer of formula (I), wherein Z is —O—, m is 2, R¹ is CH₃, and R_{f}¹ has 6 carbon atoms.

4. The emulsion polymer of claim 1 wherein component (c) is a mixture of fluorinated monomers of formula (I), wherein Z is —O—, m is 2, R¹ is CH₃, and R_{f}¹ has 4 and 6 carbon atoms.

5. The emulsion polymer of claim 1 wherein component (c) is one or more fluorinated monomer(s) of formula (II), wherein Z is —O—, q is 1 or 2, r is 1, R¹ is CH₃, and R_{f}² has 6 carbon atoms.

6. The emulsion polymer of claim 1 wherein component (c) is the fluorinated monomer of formula (III), wherein Z is —O—, q is 1, r is 1, R¹ is CH₃, and R_{f}³ has 3 carbon atoms.

7. The emulsion polymer of claim 1 wherein component (a) is an alkyl (meth)acrylate selected from stearyl (meth)acrylate, 2-ethylhexyl (meth)acrylate, hexyl(meth)acrylate, cyclohexyl(meth)acrylate, lauryl (meth)acrylate, tridecyl (meth)acrylate, or a mixture thereof.

8. The emulsion polymer of claim 1 wherein component (b) comprises from about 10 to about 45% by weight of vinylidene chloride.

9. The emulsion polymer of claim 1 wherein component (d) is an alkyl (meth)acrylate selected from the group consisting of stearyl(meth)acrylate, 2-ethylhexyl(meth)acrylate, hexyl(meth)acrylate, cyclohexyl(meth)acrylate, lauryl(meth)acrylate, tridecyl(meth)acrylate, or a mixture thereof.

10. The emulsion polymer of claim 1 further comprising one or more materials selected from the group consisting of a surfactant, pH adjuster, cross linker, wetting agent, blocked isocyanate, wax extender, and hydrocarbon extender.

11. A method of treating a fibrous substrate to impart oil repellency and water repellency comprising applying to the surface of the substrate a core-shell emulsion polymer comprising
A) a core composition, prepared from a first polymerization, comprising, on a water-free and surfactant-free basis, components (a) and (b):
(a) from about 40 to about 95% by weight of one or more monomers selected from the group consisting of styrene; alkyl substituted styrene wherein said alkyl is a linear, cyclic or branched hydrocarbon having 1 to 18 carbons; and alkyl (meth)acrylate wherein said alkyl is a linear, cyclic or branched hydrocarbon having 6 to 18 carbons; and
(b) from about 5 to about 60% by weight of one or more monomer(s) derived from the group consisting of vinylidene chloride; vinyl chloride; and combinations thereof; and
B) a shell composition, prepared from a second polymerization in the presence of the core composition, comprising, on a water-free and surfactant-free basis, components (c) and (d):
c) from about 50 to about 85% by weight of one or more fluorinated monomers of formula (I), (II) or (III):
(I) R_{f}¹(CH₂)ₘZ-C(O)—C(R¹)═CH₂
(II) R_{f}²(CH₂CF₂)_{q}(CH₂CH₂)ᵣZ-C(O)—C(R¹)═CH₂
(III) R_{f}³O(CF₂CF₂)_{q}(CH₂CH₂)ᵣZ-C(O)—C(R¹)═CH₂
wherein
m is an integer of 1 to about 6;
q and r are each independently an integer of 1 to about 3;
R¹ is hydrogen, Cl, F or CH₃;
Z is —O—, —NH— or —S—;
R_{f}¹ is a linear or branched perfluoroalkyl group having 4 or 6 carbon atoms;
R_{f}² is a linear or branched perfluoroalkyl group having from about 4 to about 6 carbon atoms; and
R_{f}³ is a linear or branched perfluoroalkyl group having from about 2 to about 7 carbon atoms optionally interrupted by one, two or three ether oxygen atoms; and
d) from about 15 to about 50% by weight of monomers selected from the group consisting of styrene; alkyl substituted styrene wherein said alkyl is a linear, cyclic or branched hydrocarbon having 1 to 18 carbons; and alkyl (meth)acrylate wherein said alkyl is a linear, cyclic or branched hydrocarbon having 6 to 18 carbons;
provided that i) the core composition comprises from about 20 to about 75% by weight of the polymer; ii) when R_{f}¹ or R_{f}² has 4 carbon atoms, R¹ is CH₃; and iii) when R_{f}³ has 2 or 3 carbon atoms, R¹ is CH₃.

12. The method of claim 11 wherein the core composition further comprises component (e):
(e) from about 0.5 to about 10% by weight of one more monomers selected from the group consisting of 2- and 4-chloromethyl styrene, vinyl acetate, N-methyloyl methacrylamide, N-methyloyl acrylamide, and monomers of the formula:
R²—(OCH₂CH₂)ₐ—O—C(O)—C(R)═CH₂
wherein
a is 1 to about 10, R is H or —CH₃, and R² is hydrogen, C₁-C₄ alkyl or —C(O)—C(R)═CH₂H.

13. The method of claim 11 wherein component (c) is the fluorinated monomer of formula (I), wherein Z is —O—, m is 2, R¹ is CH₃, and R_{f}¹ has 6 carbon atoms.

14. The method of claim 11 wherein component (c) is a mixture of fluorinated monomers of formula (I), wherein Z is —O—, m is 2, R¹ is CH₃, and R_{f}¹ has 4 and 6 carbon atoms.

15. The method of claim 11 wherein component (c) is one or more fluorinated monomer(s) of formula (II), wherein Z is —O—, q is 1 or 2, r is 1, R¹ is CH₃, and R_{f}² has 6 carbon atoms.

16. The method of claim 11 wherein component (c) is the fluorinated monomer of formula (III), wherein Z is —O—, q is 1, r is 1, R¹ is CH₃, and R_{f}³ has 3 carbon atoms.

17. The method of claim 11 wherein the core-shell emulsion polymer is applied in the presence of one or more of a surfactant, pH adjuster, cross linker, wetting agent, blocked isocyanate, wax extender, and hydrocarbon extender.

18. A fibrous substrate having applied to its surface an emulsion polymer of claim 1.

19. The fibrous substrate of claim 18 having a fluorine content of from about 0.05 weight % to about 0.5 weight %.

20. The fibrous substrate of claim 18 comprising one or more materials selected from the group consisting of cotton, rayon, silk, wool, hemp, polyester, spandex, polypropylene, polyolefin, polyamide, and aramid.
